(19) United States
(12) Patent Application Publication
(10) Pub. No.: US 2020/0126355 A1
(43) Pub. Date: Apr. 23, 2020

(54) SYSTEM AND METHOD FOR UTILIZING MOBILE DEVICE TO AUTHENTICATE TRANSACTIONS IN A GAMING ENVIRONMENT

(71) Applicant: IGT, Las Vegas, NV (US)

(72) Inventors: Fei Yi, Beijing (CN); Wei Gong, Beijing (CN)

(21) Appl. No.: 16/166,980

(22) Filed: Oct. 22, 2018

(51) Int. Cl. G07F 17/32; G06Q 20/40; G06F 21/32

(52) U.S. Cl. CPC G07F 17/3241; G07F 17/3223; G06F 21/32; G06Q 20/40145

(57) ABSTRACT

A system which utilizes an application running on a mobile device to authenticate and authorize one or more transactions associated with a gaming establishment component using identifying information, such as biometric information, captured by the mobile device.

### BACKGROUND

Certain gaming establishments, such as casinos, may include components which periodically require one or more inputs from gaming establishment personnel. Accessing these components may be both time consuming for gaming establishment personnel and potentially insecure.

### BRIEF SUMMARY

In certain embodiments, the present disclosure relates to a gaming establishment component including a network interface, a processor, and a memory device which stores a plurality of instructions. When executed by the processor responsive to an occurrence of an initiation of an authenticable task, the instructions cause the processor to wirelessly communicate, via the network interface and to a mobile device, data associated with the authenticable task. Additionally, when executed by the processor responsive to receipt, via the network interface and from the mobile device, of data authenticating a user of the mobile device, the instructions cause the processor to continue with the authenticatable task.

In certain embodiments, the present disclosure relates to a gaming establishment component including a network interface, a processor, and a memory device which stores a plurality of instructions. When executed by the processor responsive to an occurrence of an initiation of an authenticable task, the instructions cause the processor to wirelessly communicate, via the network interface and to a mobile device, data associated with the authenticable task. Additionally, when executed by the processor responsive to an authentication of a user of the mobile device associated with the authenticable task, the instructions cause the processor to associate a digital signature of the user of the mobile device with the authenticable task, wherein the authentication of the user of the mobile device is based on data authenticating the user of the mobile device received from the mobile device.

In certain embodiments, the present disclosure relates to a method of operating a gaming establishment component, the method including, responsive to an occurrence of an initiation of an authenticable task, wirelessly communicating, via a network interface and to a mobile device, data associated with the authenticable task. The method also including, responsive to receipt, via the network interface and from the mobile device, of data authenticating a user of the mobile device, continuing, by a processor, with the authenticatable task.

Additional features are described herein, and will be apparent from the following Detailed Description and the figures.

### BRIEF DESCRIPTION OF THE SEVERAL VIEWS OF THE DRAWINGS

FIG. 1 is a flowchart of one embodiment of the system disclosed herein illustrating a user authenticating their identification to a gaming establishment component via a mobile device.

FIGS. 2A, 2B, and 2C are example configurations of the architecture of a system which enables a user of a gaming establishment component to be authenticated via a mobile device.

### DETAILED DESCRIPTION

In various embodiments, the system disclosed herein utilizes an application running on a mobile device to authenticate and authorize one or more transactions associated with a gaming establishment component using identifying information, such as biometric information, captured by the mobile device.

More specifically, the system of the present disclosure enables a mobile device running a mobile device authenticator application to identify a user, such as utilizing biometric information of the user. Following such identification of the user utilizing the mobile device, authentication data associated with the user is verified prior to the system authorizing a gaming establishment component to commence with a transaction which requires the user's identification and input. In certain embodiments, to enable a user, such as a gaming establishment personnel, to log into a gaming establishment component, such as a gaming establishment workstation, following a pairing of a mobile device associated with the user and the gaming establishment component, the mobile device communicates user identification/authentication information to the gaming establishment component to facilitate the logging in process at the gaming establishment component. In certain embodiments, to enable a user to electronically sign a document associated with the gaming establishment, such as a player of an electronic gaming machine (“EGM”) electronically signing a hand-pay receipt or a gaming establishment employee electronically signing a gaming table transaction slip, following a pairing of a mobile device associated with the user and the gaming establishment component, the mobile device communicates user identification/authentication information to the gaming establishment component to facilitate the digital signature of an electronic document associated with the gaming establishment. As such, to bolster security via enhancing how users are identified and authenticated in accessing one or more gaming establishment components, such as gaming establishment workstations, the system disclosed herein reduces or eliminates inputs made at such gaming establishment components via utilizing data obtained from a mobile device, such as biometric data captured from the mobile device. This use of a mobile device to obtain data associated with a user in a relatively private setting automates and secures the entry of data previously accomplished, in a relatively public setting, by hand at the gaming establishment component. This configuration of utilizing a mobile device, and specifically tapping the biometric capturing capabilities associated with a mobile device, for one or more users provides that certain transactions which occur in a gaming environment are authenticated and authorized by the intended users and thus more secure (i.e., less susceptible to fraud and other malicious activities).

Certain gaming establishments, such as casinos, include many components which periodically require one or more inputs from gaming establishment personnel. One such gaming establishment component includes a workstation of a table manager wherein inputs are made to, amongst other activities, coordinate the operation of one or more gaming tables within the gaming establishment. Another such gaming establishment component includes a workstation of a cage and table accounting system wherein inputs are made to, amongst other activities, coordinate the handling of gaming chips at one or more gaming tables within the gaming establishment. While these components provide numerous benefits in a gaming establishment's offerings, accessing these components can be both time consuming for gaming establishment personnel and potentially insecure. For example, when a pit boss logs into a gaming establishment table manager system, the login process occurs in a public area such that the pit boss' credentials (e.g., user name and password) are vulnerable to being seen by undesirable gaming establishment patrons. In another example, when the gaming establishment opens or closes a gaming table for play and/or adds gaming chips to a gaming table, one or more paper transaction slips need to be signed by authorized gaming establishment personnel, such as a pit boss. Not only do such paper transaction slips need to be retained and audited for accounting purposes (which is both time consuming and creates environmental waste), but such paper transaction slips may be subject to signature fraud when signed by unauthorized personnel. On the other hand, a digital signature is significantly more difficult to forge on gaming establishment paperwork and thus the implementation of digital signatures can reduce loss of cheating.

Another such gaming establishment component includes an EGM which offers one or more games of chance or skill. However, certain events that occur at EGMs prevent operation of the EGMs and require the assistance of gaming establishment personnel to render the EGMs operational. For instance, when a casino patron playing at an EGM wins an award above a designated amount, the EGM prevents further play until a casino attendant travels to the EGM to verify the award and provides the casino patron with a hand payment which must be signed by the player and then authorized by the casino attendant's supervisor (which often occurs in front of the casino attendant and puts the supervisor's credentials (e.g., user name and password) at risk).

In view of these security risks associated with certain gaming establishment components, as indicated above, the system disclosed herein employs a secondary device (e.g., a mobile device), and in certain embodiments, the ability of the secondary device to capture biometric data associated with a user, to introduce an additional layer of authentication to how a user interacts with one or more of the gaming establishment components. That is, the system disclosed herein utilizes data obtained from a secondary device, such as biometric data captured from the mobile device, to enhance security and ease of use in how users are identified and authenticated in accessing one or more gaming establishment components. When compared to certain authentication methods which rely on simply a username and password, employing a secondary device (and biometric data obtained from that secondary device) provides a relatively safer and more secure way to authenticate and authorize a transaction in a gaming environment.

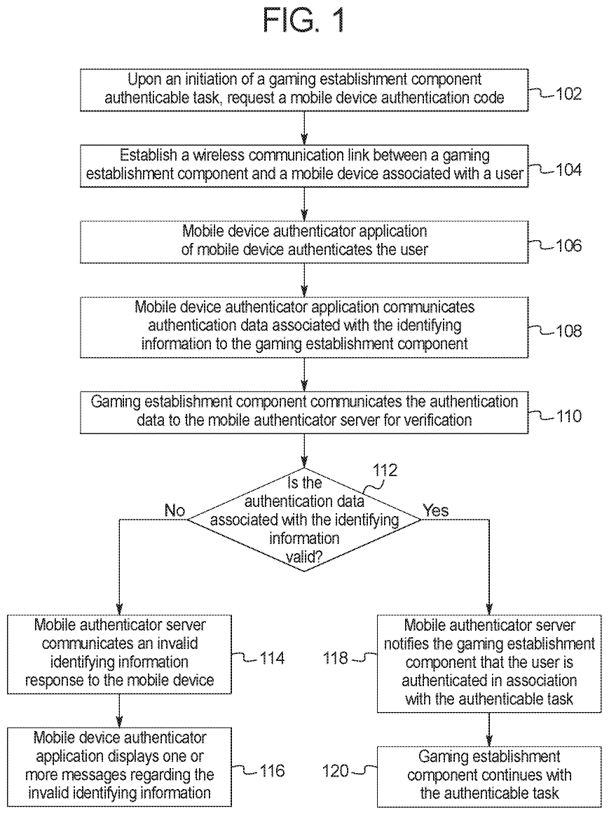

FIG. 1 is a flowchart of an example process or method of operating the system of the present disclosure. In various embodiments, the process is represented by a set of instructions stored in one or more memories and executed by one or more processors. Although the process is described with reference to the flowchart shown in FIG. 1, many other processes of performing the acts associated with this illustrated process may be employed. For example, the order of certain of the illustrated blocks or diamonds may be changed, certain of the illustrated blocks or diamonds may be optional, or certain of the illustrated blocks or diamonds may not be employed.

More specifically, upon an initiation of a gaming establishment component authenticable task, the system requests a mobile device authentication code as indicated in block 102. That is, upon a user requesting that a task that requires authentication of the user be initiated in association with a gaming establishment component, the system disclosed herein requests a mobile device authentication code prior to initiating and/or completing the requested task.

In certain embodiments, the authenticable task occurs in association with a gaming establishment personnel and includes a task which, prior to the task being initiated and/or accomplished via the gaming establishment component, requires the gaming establishment personnel to be authenticated by the system utilizing a mobile device which is distinct from the gaming establishment component.

In one such embodiment, the authenticable task includes a gaming establishment personnel logging into a gaming establishment component, wherein the mobile device authentication code is requested by the gaming establishment component to be logged into. For example, prior to a gaming establishment personnel logging into a gaming establishment workstation, the gaming establishment workstation requests a mobile device authentication code.

In another such embodiment, the authenticable task includes a gaming establishment personnel modifying operation of a gaming establishment component, wherein the mobile device authentication code is requested by the gaming establishment component prior to enabling the gaming establishment personnel to modify operation of the gaming establishment component. For example, prior to enabling a gaming establishment pit boss to open and/or close a gaming table via modifying operation of a gaming establishment table manager from a workstation, the gaming establishment table manager requests a mobile device authentication code.

In another such embodiment, the authenticable task includes a gaming establishment personnel authorizing a transaction in association with a gaming establishment component, wherein the mobile device authentication code is requested by the gaming establishment component prior to authorization of the requested transaction. For example, prior to issuing more chips to a gaming table in association with a gaming establishment table manager (i.e., an authorized transaction associated with a gaming establishment component), the gaming establishment table manager requests a mobile device authentication code. In another example, prior to issuing a line of credit or marker to a player in association with a gaming establishment cage and table accounting system (i.e., an authorized transaction associated with a gaming establishment component), the gaming establishment cage and table accounting system requests a mobile device authentication code.

In another such embodiment, the authenticable task includes one gaming establishment personnel authorizing a transaction approved by another gaming establishment personnel, wherein the mobile device authentication code is requested by the gaming establishment component prior to authorization of the requested transaction. For example, prior to authorizing a subordinate casino employee to issue a hand pay in association with a gaming establishment accounting system (i.e., an authorized transaction associated with a gaming establishment component), the gaming establishment accounting system requests a mobile device authentication code from a supervising casino employee.

In certain embodiments, the authenticable task includes gaming establishment personnel approving a transaction via associating a digital signature with the transaction, wherein the mobile device authentication code is requested by the gaming establishment component which will record the digital signature. In these embodiments, a digital signature is significantly more difficult to forge on gaming establishment paperwork and thus the implementation of digital signatures can reduce loss of cheating.

In one such embodiment which utilizes digital signatures, the authenticable task includes gaming establishment personnel authorizing a transaction with a gaming establishment cage and table accounting system (i.e., a gaming establishment component), such as gaming establishment personnel authorizing a player taking out a line of credit or marker with the gaming establishment cage and table accounting system. In this embodiment, the authorization of the transaction includes the gaming establishment personnel recording a digital signature with the gaming establishment cage and table accounting system.

In another such embodiment which utilizes digital signatures, the authenticable task includes gaming establishment personnel acknowledging a transaction with a gaming establishment component, such as gaming establishment personnel providing a player a hand pay slip or receipt issued by the gaming establishment cage and table accounting system. In this embodiment, the acknowledgment of the transaction includes the gaming establishment personnel recording a digital signature with the gaming establishment cage and table accounting system.

In another such embodiment which utilizes digital signatures, the authenticable task includes gaming establishment personnel authorizing a transaction with a gaming establishment component, such as gaming establishment personnel acknowledging a redemption, by a player, of a hand pay slip or receipt issued by the gaming establishment cage and table accounting system. In this embodiment, the authorization of the transaction includes the gaming establishment personnel recording a digital signature with the gaming establishment cage and table accounting system.

In another such embodiment, the authenticable task includes a gaming establishment personnel identifying themselves to a gaming establishment component, such as an EGM, wherein the mobile device authentication code is requested by the gaming establishment component to complete the identification. In various embodiments, the authenticable task is associated with a service floor event that requires resolution or involvement by gaming establishment personnel, such as but not limited to: (i) events that occur at EGMs that prevent operation of the EGMs; (ii) events that occur at EGMs that do not prevent operation of the EGMs, but that nevertheless demand the assistance of gaming establishment personnel and/or (iii) events that occur at EGMs that do not prevent operation of the EGMs or demand the assistance of gaming establishment personal, but for which the gaming establishment desires gaming establishment personnel involvement. In these embodiments, the service floor events which requires the gaming establishment personnel to authenticate their identity to the gaming establishment component (e.g., an EGM) occurs when one or more of: (1) a gaming establishment patron wins an award that requires a hand payment; (2) a ticket printer of an EGM runs out of paper; (3) a bill acceptor of an EGM receives a counterfeit bill or a counterfeit ticket; (4) a component of an EGM stops functioning (e.g., a display device breaks, a physical button sticks, a touch screen stops working); (5) an EGM loses its network connection; (6) an EGM loses power; (7) a bill acceptor of an EGM is full; (8) a VIP gaming establishment patron inserts their player tracking card into an EGM; (9) a gaming establishment patron having a relatively high level in the casino's player tracking system inserts their player tracking card into an EGM; (10) an EGM receives a service request from a gaming establishment patron; (11) an EGM receives a food or beverage request from a gaming establishment patron; (12) a gaming establishment patron has been playing at an EGM for at least a designated amount of time; (13) a gaming establishment patron has won at least a designated amount of money while playing an EGM; (14) a gaming establishment patron has lost at least a designated amount of money while playing an EGM; (15) a gaming establishment patron wins a designated monetary award; (16) a gaming establishment patron wins a designated non-monetary award; (17) a notable event occurs for a gaming establishment patron (e.g., the patron's birthday); (18) an EGM recognizes a cheating gaming establishment patron; (19) a general tilt condition occurs; (20) a player tracking card inserted into an EGM has been abandoned; (21) an EGM determines that a ticket has been rejected a designated quantity of times; (22) an EGM determines that a player tracking card has been rejected a designated quantity of times; (23) an EGM determines that a player tracking card has not been inserted; and/or (24) an EGM detects software failure.

It should be appreciated that the gaming establishment personnel disclosed herein may be any suitable persons such as, but not limited to: (1) hosts or hostesses, (2) concierges, (3) floor attendants, (4) pit bosses, (5) waiters and waitresses, (6) restaurant workers, (7) technicians, (8) floor managers, and/or (9) supervisors. It should also be appreciated that the gaming establishment personnel may be employed by any suitable entity, such as, but not limited to: (1) the gaming establishment; (2) a third-party contractor; and/or (3) a third-party service provider.

In certain embodiments, the authenticable task occurs in association with a player and includes a task which, prior to the task being initiated and/or accomplished via the gaming establishment component, requires the player to be authenticated by the system utilizing a mobile device which is distinct from the gaming establishment component.

In certain embodiments, the authenticable task includes a user, such as a player, approving a transaction via associating the user's digital signature with the transaction, wherein the mobile device authentication code is requested by the gaming establishment component which will record the digital signature.

In one such embodiment which utilizes digital signatures, the authenticable task includes a user, such as a player, authorizing a transaction with a gaming establishment cage and table accounting system (i.e., a gaming establishment component), such as the player taking out a line of credit or marker with the gaming establishment cage and table accounting system. In this embodiment, the authorization of the transaction includes the user recording a digital signature with the gaming establishment cage and table accounting system.

In another such embodiment which utilizes digital signatures, the authenticable task includes a user, such as a player, acknowledging a transaction with a gaming establishment component, such as the player acknowledging receipt of a hand pay slip or receipt issued by the gaming establishment cage and table accounting system. In this embodiment, the acknowledgment of the transaction includes the user recording a digital signature with the gaming establishment cage and table accounting system.

In another such embodiment which utilizes digital signatures, the authenticable task includes a user, such as a player, authorizing a transaction with a gaming establishment component, such as the player authorizing a redemption of a hand pay slip or receipt issued by the gaming establishment cage and table accounting system. In this embodiment, the authorization of the transaction includes the user recording a digital signature with the gaming establishment cage and table accounting system.

Following the request of a mobile device authentication code upon an initiation of a gaming establishment component authenticable task, the system establishes a wireless communication link between a gaming establishment component and a mobile device associated a user as indicated in block 104. That is, in addition to requesting a mobile device authentication code, the system places the gaming establishment component (which requires a mobile device authentication code to complete an authenticable task) and a mobile device (associated with an entity whom will provide authentication data to facilitate the completion of the authenticable task) in wireless communication with each other. In certain embodiments, the system places a mobile authenticator agent of a mobile authenticator server installed on the gaming establishment component, such as a gaming establishment workstation with a gaming establishment system client installed, in wireless communication with a mobile device including a mobile device authenticator application.

In certain embodiments, the communication with the mobile device can occur through one or more network interfaces, such as wireless interfaces, of the gaming establishment component which are configured to receive information. In one such embodiment, the wireless interface is integrated into the cabinet of the gaming establishment component, such as a gaming establishment workstation, and a processor of the gaming establishment component is configured to communicate directly with and send commands to the wireless interface. In another embodiment, the wireless interface is integrated into a device mounted to and/or within a cabinet of a gaming establishment component. In certain embodiments where the wireless interface is embedded in a secondary device, the processor of the gaming establishment component sends commands to control the wireless interface via a secondary controller.

In certain embodiments, the wireless communication is established via the gaming establishment component sending one or more wireless communication signals, such as Bluetooth™ signals and/or Bluetooth™ Low Energy (“BLE”) signals, one or more cellular communication standard (e.g., 3G, 4G, LTE) signals, one or more Wi-Fi compatible standard signals and/or one or more short range communication signals, such as near field communication (“NFC”) signals protocol). In certain such embodiments, following the mobile authenticator agent installed on the gaming establishment component receiving data from the mobile authenticator server to authenticate a user whom requested an authenticable task, the mobile authenticator agent installed on the gaming establishment component causes the gaming establishment component to transmit wireless signals. The transmitted wireless signals are associated with the authenticable task of the gaming establishment component. In these embodiments, the user launches the mobile device authenticator application from the user's mobile device and utilizes the received wireless signals to place the mobile device and the gaming establishment component in wireless communication with each other for the mobile device to obtain the authenticable task of the gaming establishment component.

In certain embodiments, the wireless communication is established via the scanning of one or more machine-readable codes, such as a QR code. In these embodiments, following the mobile authenticator agent installed on the gaming establishment component receiving data from the mobile authenticator server to authenticate a user whom requested an authenticable task, the mobile authenticator agent installed on the gaming establishment component causes the gaming establishment component to generate and display a machine readable code, such as the QR code displayed on a login screen of a gaming establishment workstation. The machine readable code is associated with the authenticable task of the gaming establishment component such that different generated machine readable codes are associated with different authenticable tasks. In these embodiments, the user launches the mobile device authenticator application from the user's mobile device and scans the machine readable code, such as the QR code. In one such embodiment, scanning the machine readable code with the mobile device running the mobile device authentication application places the mobile device and the gaming establishment component in wireless communication with each other for the mobile device to obtain the authenticable task of the gaming establishment component. In another such embodiment, the machine readable code includes data regarding the authenticable task such that scanning the machine readable code with the mobile device authentication application provides the authenticable task of the gaming establishment component to the mobile device.

Following the establishment of the wireless connection between the gaming establishment component and the mobile device, as indicated in block 106 of FIG. 1, the mobile device authenticator application of the mobile device authenticates the user. Put differently, the system disclosed herein utilizes a mobile device (which is distinct from a gaming establishment component) to authenticate a user of the gaming establishment component.

In certain embodiments, the mobile device authenticator application employs a multi-factor authentication process wherein the user provides identifying information and the user's identity is confirmed if the provided identifying information corresponds with two or more identification verification factors. In these embodiments, the identification verification factors include one or more knowledge-based factors (i.e., information which the user and only the user should know, such as a username, password and/or passphrase), one or more possession-based factors (i.e., information which the user and only the user should have, such as a verification code texted to the user's mobile device), and/or one or more biometric-based factors (i.e., one or more biometric identifiers associated with the user, such as a scanned fingerprint, a recognized iris and/or an identified voice).

It should be appreciated that if one or more biometric-based factors are utilized in the multi-factor authentication process, to capture one or more biometric identifiers, the mobile device includes various biometric detecting devices configured to detect individualized biometrics of a user. In one such embodiment, the mobile device includes a fingerprint detector configured to read a fingerprint of a user. In another such embodiment, the mobile device includes a retinal scanner configured to scan a user's retinas. In another such embodiment, the mobile device includes a facial recognition device configured to recognize a user's face. In different embodiments, any suitable hardware, such as cameras and microphones, and specialized software can be used to capture or measure any identifying information of a user, such as but not limited to, vein detection in palms or other body components, voice recognition, handwriting analysis, keyboard or other input styles and tendencies, eye pattern movements, shapes of fingers, hands or other body parts, thermal patterns, and/or blood pressure.

Following the user providing identifying information to authenticate themselves via the mobile device authenticator application of the mobile device, as indicated in blocks 108 and 110 of FIG. 1, the mobile device authenticator application communicates authentication data associated with the identifying information to the gaming establishment component which communicates, over one or more wired and/or wireless communication protocols, the authentication data to the mobile authenticator server for verification. That is, after utilizing the mobile device to capture identifying information of the user in a less public setting as well as harnessing the biometric capturing capabilities of a mobile device, the mobile device communicates data associated with such identifying information of the user to the gaming establishment component for verification by a verification/authentication server. In another embodiment, following the user providing identifying information to authenticate themselves via the mobile device authenticator application of the mobile device, the mobile device authenticator application communicates authentication data associated with the identifying information directly to the mobile authenticator server for verification. In another embodiment, following the user providing identifying information to authenticate themselves via the mobile device authenticator application of the mobile device, the mobile device authenticator application utilizes mobile device stored authentication data associated with the user to verify the identity of the user and then communicate authentication data associated with the verified identity of the user to the gaming establishment component.

Upon receipt of the authentication data associated with the identifying information, the mobile authenticator server determines if the authentication data associated with the identifying information is valid as indicated in diamond 112 of FIG. 1. In one such embodiment, the mobile authenticator server notifies the gaming establishment component with a signed authentication/authorization result and the gaming establishment component utilizes a public key to verify the result and determine if the authenticable task can proceed. In this embodiment, the gaming establishment component downloads public key in advance for result verification, thereby making it possible to verify the authentication result even if the mobile authenticator server is offline.

If the mobile authenticator server determines that the authentication data associated with the identifying information is invalid, the mobile authenticator server communicates an invalid identifying information response to the mobile device as indicated in block 114. The mobile device authenticator application then displays, as indicated in block 116, one or more messages regarding the invalid identifying information. In certain embodiments, the mobile device authenticator application prompts the user to again provide identifying information, such as a personal identification number and/or one or more biometric identifiers.

On the other hand, if the mobile authenticator server determines that the authentication data associated with the identifying information is valid, the mobile authenticator server notifies the gaming establishment component that the user is authenticated in association with the authenticable task as indicated in block 116. Once the user is verified as authentic in association with the authenticable task, the gaming establishment component continues with the authenticable task as indicated in block 118.

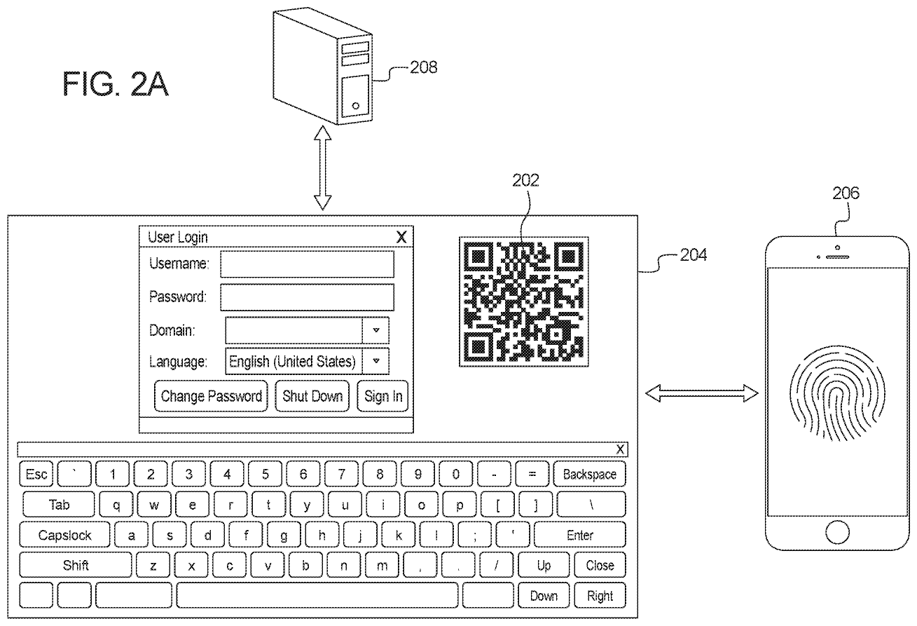

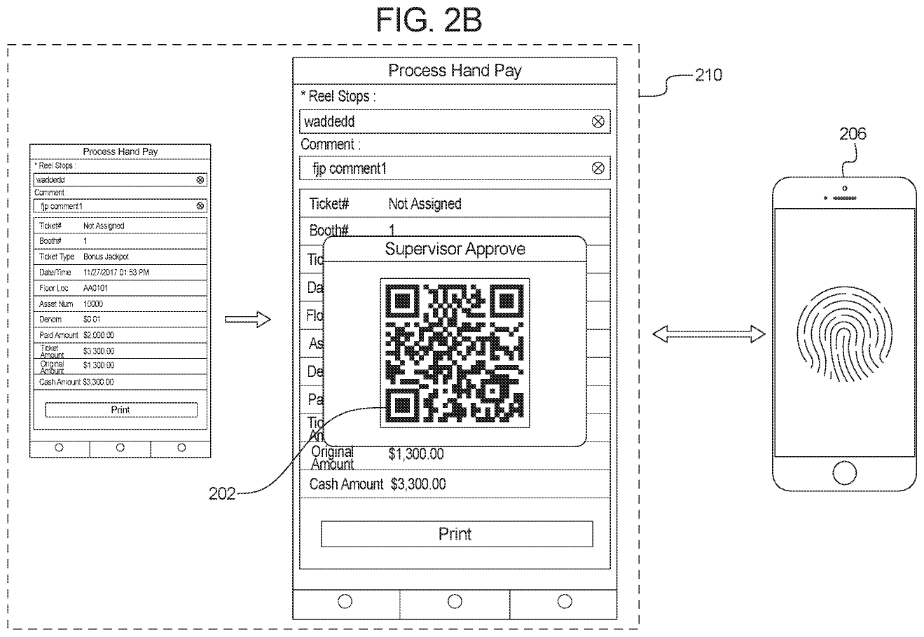

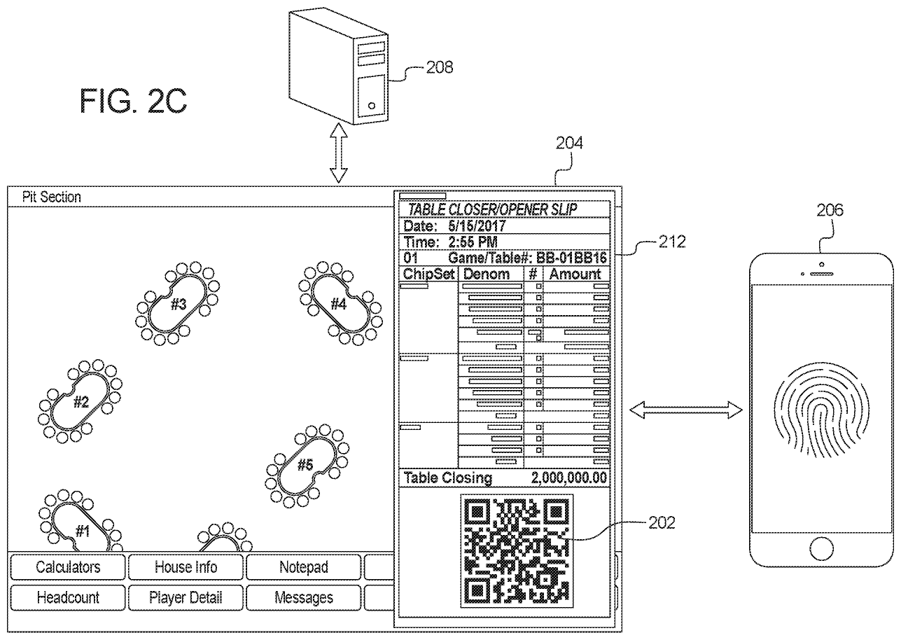

In certain embodiments, as indicated above, the authenticable task includes a gaming establishment personnel logging into a gaming establishment component, wherein after the gaming establishment personnel is authenticated by the mobile authenticator server following the user authenticating themselves via a mobile device, the gaming establishment personnel is logged into the gaming establishment component. For example, as seen in FIG. 2A, following a QR code 202 displayed by a gaming establishment workstation 204 being scanned by a mobile device 206 and after authentication data associated with the gaming establishment personnel is communicated to the gaming establishment workstation 204 and then verified by a mobile authenticator server 208 is the gaming establishment personnel logged into the gaming establishment workstation. Such a multi-device authentication process increases gaming establishment security by minimizing the chances that an unauthorized user will log themselves into a gaming establishment component, such as a gaming establishment workstation, and commit improper acts.

In another such embodiment wherein the authenticable task includes a gaming establishment personnel modifying operation of a gaming establishment component, after the gaming establishment personnel is authenticated by the mobile authenticator server following the gaming establishment personnel authenticating themselves via a mobile device, the gaming establishment personnel is authorized to modify operation of the gaming establishment component. For example, after a gaming establishment pit boss has authenticated themselves (via authentication data being captured by a mobile device and authenticated by a mobile authenticator server), a gaming establishment table manager enables the gaming establishment pit boss to open and/or close a gaming table.

In another such embodiment wherein the authenticable task includes a gaming establishment personnel authorizing a transaction in association with a gaming establishment component, after the gaming establishment personnel is authenticated by the mobile authenticator server following the gaming establishment personnel authenticating themselves via a mobile device, the gaming establishment component authorizes (or initiates the authorization) of a transaction. For example, after a gaming establishment pit boss has authenticated themselves (via authentication data being captured by a mobile device and authenticated by a mobile authenticator server), a gaming establishment table manager enables the gaming establishment pit boss to issue more chips to a gaming table. In another example, after a gaming establishment cage employee has authenticated themselves (via authentication data being captured by a mobile device and authenticated by a mobile authenticator server), a gaming establishment cage and table accounting system enables the cage employee to issue (or initiate the issuance process) of a line of credit or marker to a player.

In another such embodiment wherein the authenticable task includes one gaming establishment personnel authorizing a transaction approved by another gaming establishment personnel, after a first gaming establishment personnel is authenticated by the mobile authenticator server following the first gaming establishment personnel authenticating themselves via a mobile device, the gaming establishment component authorizes (or initiates the authorization) of a transaction in association with a second gaming establishment personnel. For example, as seen in FIG. 2B, following a subordinate gaming establishment employee creating a handpay request on their mobile gaming establishment workstation 210, a QR code 202 displayed by the mobile gaming establishment workstation 210 is scanned by a mobile device 206 of a supervisor gaming establishment employee. In this example, after authentication data associated with the supervisor gaming establishment employee is communicated to the mobile gaming establishment workstation 210 and then verified by a mobile authenticator server is the subordinate gaming establishment employee authorized to issue a handpay to a player. Such a configuration deters gaming establishment employee fraud by providing that authorized and verified gaming establishment personnel approve these transactions.

In another such embodiment wherein the authenticable task includes a gaming establishment personnel identifying themselves to a gaming establishment component, after the gaming establishment personnel is authenticated by the mobile authenticator server following the gaming establishment personnel authenticating themselves via a mobile device, the gaming establishment component enables the gaming establishment personnel to complete their identification. For example, after a gaming establishment employee has authenticated themselves (via authentication data being captured by a mobile device and authenticated by a mobile authenticator server), an EGM enables the gaming establishment employee to identify themselves to the EGM in association with a server floor event.

In certain embodiments, as indicated above, the authenticable task is associated with a digital signature of a user, wherein upon the gaming establishment component continuing with the authenticable task, the user's digital signature is assigned to the authenticable task. In these embodiments, the authentication data includes data associated with the user's digital signature wherein upon the authentication data associated with the identifying information being determined as valid, the user's digital signature is assigned or otherwise recorded in association with the authenticable task. That is, after a user, such as a player or a gaming establishment personnel, is authenticated by the mobile authenticator server following the user authenticating themselves via a mobile device, a gaming establishment component assigns the user's digital signature to the authenticable task and authorizes (or initiates the authorization) of the task. For example, as seen in FIG. 2C, after a user, such as a player and/or a gaming establishment cage employee has authenticated themselves at a workstation 204 (via authentication data being captured by a mobile device 206 and authenticated by a mobile authenticator server 208), a gaming establishment cage and table accounting system records a digital signature of the user in association with digital paperwork 212 which is stored to evidence that the player took out a line of credit or marker with the gaming establishment cage and table accounting system.

In another example, after a user, such as a player and/or a gaming establishment employee has authenticated themselves (via authentication data being captured by a mobile device and authenticated by a mobile authenticator server), a gaming establishment accounting system records a digital signature of the user in association with digital paperwork which is stored to evidence that the player received a hand pay in association with their gaming experience. In another example, after a user, such as a player and/or a gaming establishment employee has authenticated themselves (via authentication data being captured by a mobile device and authenticated by a mobile authenticator server), a gaming establishment accounting system records a digital signature of the user in association with digital paperwork which is stored to evidence that the player redeemed a pay slip or receipt associated with a hand pay issued in association with their gaming experience.

In certain embodiments, in addition to employing a multi-factor authentication process to verify an identify of the user of the mobile device, the mobile device authenticator application of the mobile device utilizes an authorization token to ensure that the user is properly authenticated using the mobile device. In certain embodiments, after a user has opened a mobile device authenticator application on a mobile device and made one or more inputs to authenticate themselves, the system determines if the mobile device authenticator application is associated with an active authorization token previously created by the system. In these embodiments, an authorization token is a time-based token which expires after a designated period of time and which is associated with an additional level of user authentication.

In certain embodiments which utilize an NFC implementation as indicated above, the mobile device authenticator application registers with one or more processors of the mobile device. In these embodiments, when the mobile device is detected by an NFC reader of a gaming establishment component, the gaming establishment component communicates one or more data messages to the mobile device (or to one or more servers which then communicate such data messages to the mobile device). Such data messages are commands generated by the gaming establishment component when the mobile device is detected in the NFC reader field. The processor of the mobile device communicates the data message to the mobile device authenticator application. The mobile device authenticator application responds, such as communicating a triggering message, and a communication channel is opened between the gaming establishment component and the mobile device authenticator application (or between the gaming establishment component, one or more servers and the mobile device authenticator application). This open communication channel enables the gaming establishment component to send, though the NFC reader, additional data messages to the mobile device (or to the mobile device via one or more servers) which are responded to by the mobile device authenticator application of the mobile device. It should be appreciated that as long as the mobile device remains within the NFC field, the gaming establishment component is configured to communicate with the mobile device and send data, such as status updates, as necessary. However, once the mobile device is removed from the NFC field, the communication channel is closed and such status updates must be discontinued.

In certain embodiments which utilize a Bluetooth™ implementation, a Bluetooth pairing occurs when two Bluetooth devices agree to communicate with each other and establish a connection. In order to pair two Bluetooth wireless devices, a password (passkey) is exchanged between the two devices. The Passkey is a code shared by both Bluetooth devices, which proves that both users have agreed to pair with each other. After the passkey code is exchanged, an encrypted communication can be set up between the pair devices. In Wi-Fi paring, every pairing can be set up with WPA2 encryption or another type of encryption scheme to keep the transfer private. Wi-Fi Direct is an example of a protocol that can be used to establish point-to-point communications between two Wi-Fi devices. The protocol enables for a Wi-Fi device pair directly with another without having to first join a local network.

It should be appreciated that Wi-Fi, cellular or Bluetooth™ communication protocols can be used in lieu of or in combination with NFC. For instance, an NFC communication can be used to instantiate a Wi-Fi or Bluetooth™ communication between the gaming establishment component, zero, one or more servers and a mobile device, such as secure pairing using one of these protocols. That is, in one embodiment, an NFC interface on a gaming establishment component can be used to set-up a higher speed communication between the gaming establishment component, zero, one or more servers and the NFC enabled mobile device. The higher speed communication rates can be used for expanded content sharing. For instance, a NFC and Bluetooth enabled gaming establishment component can be tapped by an NFC and Bluetooth enabled mobile device for instant Bluetooth pairing between the devices and zero, one or more servers. Instant Bluetooth pairing between a gaming establishment component, an NFC enabled mobile device and zero, one or more servers, can save searching, waiting, and entering codes. In another example, a gaming establishment component can be configured as an NFC enabled router, such as a router supporting a Wi-Fi communication standard. Tapping an NFC enabled mobile device to an NFC enabled and Wi-Fi enabled gaming establishment component can be used to establish a Wi-Fi connection between the devices and zero, one or more servers.

In certain embodiments which implement a Wi-Fi, cellular and/or Bluetooth™ communications protocol, as indicated above, the system utilizes one or more machine readable codes, such as QR codes generated by the gaming establishment component to facilitate the communication of data between the mobile device and the system. In such embodiments, the QR code is used to identify the gaming establishment component that is displaying the QR code to identify the server to which the mobile device should connect. It should be appreciated that the QR code enables the system to establish a secure tunnel or path from the mobile device to the gaming establishment's Wi-Fi network and then to the gaming establishment's wired network and finally to the gaming establishment component. In these embodiments, a communication tunnel wrapper (i.e., a Wi-Fi/Bluetooth™ tunnel wrapper) is utilized to establish a connection between the gaming establishment component and the mobile device and to transport any data messages between the gaming establishment component, zero, one or more servers and the mobile device.

More specifically, in certain embodiments, the user requests, via an input at the gaming establishment component and/or the mobile device, the generation of a QR code by the gaming establishment component. In response to the user's request (or automatically upon an initiation of a gaming establishment component authenticable task), the gaming establishment component displays a QR code. In certain embodiments, the QR code includes a nonce which prevents a third-party (e.g., another user) from sniping the user's attempt. Such an on-demand QR code remains valid for a designated amount of time such that if the use does not scan the QR code within the designated amount of time, another QR code is necessary to be scanned to connect the mobile device to the gaming establishment component.

In these embodiments, the user scans the QR code with the mobile device authenticator application. If the system determines that the QR code is valid (i.e., not expired), the mobile device authenticator application will connect to the system. It should be appreciated that as long as the established connection between the mobile device and the system remains active, one or more servers and mobile device may communicate data, such as status updates, as necessary. It should be further appreciated that in association with the Wi-Fi or Bluetooth™ or mobile device network communications protocol described herein, any action requested by the user via the mobile device authenticator application does not require a new engagement between the mobile device and the gaming establishment component, such as a new scanning of the QR code to send such a requested action from the mobile device to the gaming establishment component (or to send a requested action from the mobile device to one or more servers and then from one or more servers to the gaming establishment component).

In certain embodiments, following the scanning of a valid QR code, the mobile device authenticator application connects to one or more servers. For example, such servers use websockets secured with a transport layer security protocol or other similar mechanisms. In one such embodiment, the servers operate with one or more translators and zero, one or more components of the system, similarly using websockets secured with a transport layer security protocol, to communicate data to the gaming establishment component. It should be appreciated that in certain embodiments, one or more of the servers are scalable servers configured to scale to accept connections from thousands of mobile devices.

In certain embodiments, after establishing a connection with one or more servers, the mobile device authenticator application transmits a connect command to the system. In response to receiving a connect command from the mobile device, the system sends a message to the mobile device. This message serves to encapsulate various commands between the system and the mobile device. In these embodiments, if the mobile device authenticator application does not receive this message within a designated period of time, such as within five seconds, the mobile device authenticator application displays an error message to the player and directs the user to rescan the QR code.

In addition to the connect command communicated from the mobile device authenticator application to the system, the mobile device authenticator application of these embodiments is configured to send a disconnect command to the system. Such a disconnect command functions to tear-down the connection the server. That is, after the server receives the disconnect command from the mobile device authenticator application, the server sends this disconnect command to the translator and close the websocket to the mobile device authenticator application. In these embodiments, if the websocket is not closed or otherwise terminated within a designated period of time, such as five seconds, the mobile device authenticator application may retry communicating this command or close the websocket. It should be appreciated that if the mobile device connection is severed before this command is received by the system, the server sends this command on behalf of the mobile device authenticator application.

In another embodiment, the mobile device authenticator application is configured to send a trigger command to the system, such as the gaming establishment component. In this embodiment, the trigger command is associated with an action requested by the user. In such embodiments, when the system receives the trigger command from the mobile device authenticator application, the system will communicate the appropriate requests to the mobile device authenticator application. If the mobile device authenticator application does not receive these requests within a designated amount of time, such as five seconds, the mobile device authenticator application will display an error message to the user and enable the user to retry the requested action.

In other embodiments, the mobile device authenticator application communicates with the system through a tunnel established over the mobile device's Wi-FI network or the mobile device's network connection. In such embodiments, the mobile device authenticator application will connect to one or more servers which use websockets secured with a transport layer security protocol. The server operates with one or more translators, similarly using websockets secured with a transport layer security protocol to communicate data to the gaming establishment component.

In certain embodiments which utilize the NFC communication protocol described herein, which utilize the Wi-Fi, cellular and/or Bluetooth™ communication protocols described herein and/or which utilize any other communication protocol described herein, any action requested by the user via the mobile device authenticator application requires a new engagement between the mobile device and the gaming establishment component, such as a new tap of the mobile device to a designated location of the gaming establishment component. In certain other embodiments which utilize the NFC communication protocol described herein, which utilize the Wi-Fi, cellular and/or Bluetooth™ communication protocols described herein and/or which utilize any other communication protocol described herein, certain actions requested by the user via the mobile device authenticator application requires a new engagement between the mobile device and the gaming establishment component, such as a new tap of the mobile device to a designated location of the gaming establishment component and other actions requested by the user via the mobile device authenticator application do not require any new engagement between the mobile device and the gaming establishment component.

In various embodiments, one or more gaming establishment components and/or the mobile authenticator server includes a controller configured to communicate with and to operate with a plurality of peripheral devices. The controller includes at least one processor which is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source via a communication interface of the controller; (2) converting signals read by an interface to a format corresponding to that used by software or memory of the one or more gaming establishment components and/or the mobile authenticator server; (3) accessing memory to configure or reconfigure parameters in the memory according to indicia read from the one or more gaming establishment components and/or the mobile authenticator server; (4) communicating with interfaces and the peripheral devices (such as input/output devices); and/or (5) controlling the peripheral devices. In certain embodiments, one or more components of the controller (such as the at least one processor) reside within a housing of the one or more gaming establishment components and/or the mobile authenticator server while in other embodiments at least one component of the controller resides outside of the housing of the one or more gaming establishment components and/or the mobile authenticator server.

The controller also includes at least one memory device, which includes: (1) volatile memory (e.g., RAM, which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information. Any other suitable magnetic, optical, and/or semiconductor memory may operate in conjunction with the one or more gaming establishment components and/or the mobile authenticator server disclosed herein. In certain embodiments, the at least one memory device resides within the housing of the one or more gaming establishment components and/or the mobile authenticator server, while in other embodiments at least one component of the at least one memory device resides outside of the housing of the one or more gaming establishment components and/or the mobile authenticator server.

The at least one memory device is configured to store, for example: (1) configuration software, (2) associations between configuration indicia read from one or more gaming establishment components and/or the mobile authenticator server with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the one or more gaming establishment components and/or the mobile authenticator server to communicate with local and non-local devices using such protocols. In one implementation, the controller communicates with other devices using a serial communication protocol. A few non-limiting examples of serial communication protocols that other devices, such as peripherals may use to communicate with the master game controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the one or more gaming establishment components and/or the mobile authenticator server to control the one or more gaming establishment components and/or the mobile authenticator server. In various embodiments, part or all of the program code and/or the operating data is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a user uses such a removable memory device in one or more gaming establishment components and/or the mobile authenticator server to implement at least part of the present disclosure. In other embodiments, part or all of the program code and/or the operating data is downloaded to the at least one memory device of the one or more gaming establishment components and/or the mobile authenticator server through any suitable data network (such as an Internet or intranet).

The at least one memory device also stores a plurality of device drivers. Typically, the device drivers utilize various communication protocols that enable communication with a particular physical device. The device driver abstracts the hardware implementation of that device. For example, a device driver may be written for each type of card reader that could potentially be connected to the EGM. Non-limiting examples of communication protocols used to implement the device drivers include Netplex, USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor loads the new device driver from the at least one memory device to enable communication with the new device. For instance, one type of card reader in an EGM can be replaced with a second different type of card reader when device drivers for both card readers are stored in the at least one memory device.

In certain embodiments, the software units stored in the at least one memory device can be upgraded as needed. For instance, when the at least one memory device is a hard drive, new games, new game options, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store game options, parameters, and settings, the software stored in the at least one memory device can be upgraded by replacing a first CD/DVD with a second CD/DVD. In yet another example, when the at least one memory device uses flash memory or EPROM units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device also stores authentication and/or validation components configured to authenticate/validate specified components and/or information, such as hardware components, software components, firmware components, peripheral device components, user input device components, information received from one or more user input devices, information stored in the at least one memory device, etc. Examples of various authentication and/or validation components are described in U.S. Pat. No. 6,620,047, entitled “Electronic Gaming Apparatus Having Authentication Data Sets”.

In certain embodiments, the peripheral devices include several device interfaces, such as: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one player/device tracking module; and (14) at least one information filtering module.

The at least one output device includes at least one display device configured to display any information displayed by the one or more gaming establishment components and/or the mobile authenticator server, such as any game(s) displayed by an EGM and any suitable information associated with such game(s). In certain embodiments, the display devices are connected to or mounted on a housing of the one or more gaming establishment components and/or the mobile authenticator server. In various embodiments, the display devices serve as digital glass configured to advertise certain games or other aspects of the gaming establishment in which an EGM is located. In various embodiments, wherein the gaming establishment component includes an EGM, the EGM includes one or more of the following display devices: (a) a central display device; (b) a player tracking display configured to display various information regarding a player's player tracking status; (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, the display device includes a touch-screen with an associated touch-screen controller. The display devices may be of any suitable sizes, shapes, and configurations.

The display devices are configured to display one or more game and/or non-game images, symbols, and indicia. In certain embodiments, the display devices are configured to display any suitable visual representation or exhibition of the movement of objects; dynamic lighting; video images; images of people, characters, places, things, and faces of cards; and the like. In certain embodiments, the display devices are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device includes a payout device. In certain embodiments wherein the gaming establishment component includes an EGM, after the EGM receives an actuation of a cashout device, the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. Examples of ticket-in ticket-out (TITO) technology are described in U.S. Pat. No. 5,429,361, entitled “Gaming Machine Information, Communication and Display System”; U.S. Pat. No. 5,470,079, entitled “Gaming Machine Accounting and Monitoring System”; U.S. Pat. No. 5,265,874, entitled “Cashless Gaming Apparatus and Method”; U.S. Pat. No. 6,729,957, entitled “Gaming Method and Host Computer with Ticket-In/Ticket-Out Capability”; U.S. Pat. No. 6,729,958, entitled “Gaming System with Ticket-In/Ticket-Out Capability”; U.S. Pat. No. 6,736,725, entitled “Gaming Method and Host Computer with Ticket-In/Ticket-Out Capability”; U.S. Pat. No. 7,275,991, entitled “Slot Machine with Ticket-In/Ticket-Out Capability”; and U.S. Pat. No. 6,048,269, entitled “Coinless Slot Machine System and Method”. In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player. Examples of providing payment using virtual tickets are described in U.S. Pat. No. 8,613,659, entitled “Virtual Ticket-In and Ticket-Out on a Gaming Machine”.

In certain embodiments, the at least one output device is a sound generating device controlled by one or more sound cards. In one such embodiment, the sound generating device includes one or more speakers or other sound generating hardware and/or software configured to generate sounds.

The at least one input device may include any suitable device that enables an input signal to be produced and received by the at least one processor.

In one embodiment wherein the gaming establishment component includes an EGM, the at least one input device includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof.

In one embodiment wherein the gaming establishment component includes an EGM, the at least one input device includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. Examples of funding an EGM via communication between the EGM and a mobile device (such as a mobile phone) of a player are described in U.S. Patent Application Publication No. 2013/0344942, entitled “Avatar as Security Measure for Mobile Device Use with Electronic Gaming Machine”. When the EGM is funded, the at least one processor determines the amount of funds entered and displays the corresponding amount on a credit display or any other suitable display.

In certain embodiments wherein the gaming establishment component includes an EGM, the at least one input device includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM that is actuatable via a touch screen of the EGM or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously-placed wager on a play of a game. A further such wagering or betting device is a bet one device that, when actuated, causes the EGM to increase the wager by one credit. Generally, upon actuation of one of the wagering or betting devices, the quantity of credits displayed in a credit meter decreases by the amount of credits wagered, while the quantity of credits displayed in a bet display increases by the amount of credits wagered. While any credit balances, any wagers, any values, and any awards are described herein as amounts of monetary credits or currency, one or more of such credit balances, such wagers, such values, and such awards may be for non-monetary credits, promotional credits, of player tracking points or credits.

In various embodiments wherein the gaming establishment component includes an EGM, the at least one input device includes at least one game play activation device. In various embodiments, the one or more game play initiation devices are each: (1) a mechanical button supported by the housing of the EGM (such as a hard key or a programmable soft key), or (2) an icon displayed on a display device of the EGM that is actuatable via a touch screen of the EGM or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game.

In other embodiments wherein the gaming establishment component includes an EGM, the at least one input device includes a cashout device. In various embodiments, the cashout device is: (1) a mechanical button supported by the housing of the EGM (such as a hard key or a programmable soft key), or (2) an icon displayed on a display device of the EGM that is actuatable via a touch screen of the EGM or via use of a suitable input device of the EGM (such as a mouse or a joystick). When the EGM receives an actuation of the cashout device from a player and the player has a positive (i.e., greater-than-zero) credit balance, the EGM initiates a payout associated with the player's credit balance.

In various embodiments, the at least one input device includes a plurality of buttons that are programmable to, when actuated, cause the one or more gaming establishment components and/or the mobile authenticator server to perform particular functions. For instance, such buttons may be hard keys, programmable soft keys, or icons icon displayed on a display device of the one or more gaming establishment components and/or the mobile authenticator server that are actuatable via a touch screen or via use of a suitable input device of the EGM (such as a mouse or a joystick).

In certain embodiments, the at least one input device includes a touch-screen coupled to a touch-screen controller or other touch-sensitive display overlay to enable interaction with any images displayed on a display device. One such input device is a conventional touch-screen button panel. The touch-screen and the touch-screen controller are connected to a video controller. In these embodiments, signals are input by touching the touch screen at the appropriate locations.

In certain embodiments wherein the gaming establishment component includes an EGM including a player tracking system, the at least one input device includes a card reader in communication with the at least one processor of the EGM. The card reader is configured to read a player identification card inserted into the card reader.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the one or more gaming establishment components and/or the mobile authenticator server. In one embodiment, a user input device docking region is provided, and includes a power distribution component that is configured to recharge a user input device without requiring metal-to-metal contact. In one embodiment, the at least one power distribution component is configured to distribute power to one or more internal components of the one or more gaming establishment components and/or the mobile authenticator server, such as one or more rechargeable power sources (e.g., rechargeable batteries) located at the one or more gaming establishment components and/or the mobile authenticator server.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the one or more gaming establishment components and/or the mobile authenticator server; detecting the presence and/or identity of various persons (e.g., players, casino employees, etc.), devices (e.g., user input devices), and/or systems within a predetermined proximity to the one or more gaming establishment components and/or the mobile authenticator server.

The at least one data preservation component is configured to detect or sense one or more events and/or conditions that, for example, may result in damage to the one or more gaming establishment components and/or the mobile authenticator server and/or that may result in loss of information associated with the one or more gaming establishment components and/or the mobile authenticator server. Additionally, the data preservation system may be operable to initiate one or more appropriate action(s) in response to the detection of such events/conditions.

The at least one motion/gesture analysis and interpretation component is configured to analyze and/or interpret information relating to detected movements and/or gestures to determine appropriate input information relating to the detected movements and/or gestures. For example, in one embodiment, the at least one motion/gesture analysis and interpretation component is configured to perform one or more of the following functions: analyze the detected gross motion or gestures of a user; interpret the user's motion or gestures to identify instructions or input from the user; utilize the interpreted instructions/input to advance the state of the one or more gaming establishment components and/or the mobile authenticator server. In other embodiments, at least a portion of these additional functions may be implemented at a remote system or device.

The at least one portable power source enables the one or more gaming establishment components and/or the mobile authenticator server to operate in a mobile environment. For example, in one embodiment, the one or more gaming establishment components and/or the mobile authenticator server includes one or more rechargeable batteries.

The at least one geolocation module is configured to acquire geolocation information from one or more remote sources and use the acquired geolocation information to determine information relating to a relative and/or absolute position of the one or more gaming establishment components and/or the mobile authenticator server. For example, in one implementation, the at least one geolocation module is configured to receive GPS signal information for use in determining the position or location of the one or more gaming establishment components and/or the mobile authenticator server. In another implementation, the at least one geolocation module is configured to receive multiple wireless signals from multiple remote devices and use the signal information to compute position/location information relating to the position or location of the one or more gaming establishment components and/or the mobile authenticator server.

The at least one user identification module is configured to determine the identity of the current user or current owner of the one or more gaming establishment components and/or the mobile authenticator server. For example, in one embodiment wherein the gaming establishment component includes an EGM, the current user is required to perform a login process at the EGM in order to access one or more features. Alternatively, the EGM is configured to automatically determine the identity of the current user based on one or more external signals, such as an RFID tag or badge worn by the current user and that provides a wireless signal to the EGM that is used to determine the identity of the current user. In at least one embodiment, various security features are incorporated into the EGM to prevent unauthorized users from accessing confidential or sensitive information.

The at least one information filtering module is configured to perform filtering (e.g., based on specified criteria) of selected information to be displayed at one or more displays.

In various embodiments, the one or more gaming establishment components and/or the mobile authenticator server includes a plurality of communication ports configured to enable the at least one processor of the one or more gaming establishment components and/or the mobile authenticator server to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices. U.S. Pat. No. 7,290,072 describes a variety of EGMs including one or more communication ports that enable the EGMs to communicate and operate with one or more external peripherals.

It should be appreciated that the above-described embodiments of the present disclosure may be implemented in accordance with or in conjunction with one or more of a variety of different types of gaming establishment components as described herein. Such gaming establishment components may refer to various configurations of: (a) one or more central servers, central controllers, or remote hosts; (b) one or more gaming establishment components, such as EGMs such as those located on a casino floor; and/or (c) one or more secondary devices, such as desktop computers, laptop computers, tablet computers or computing devices, personal digital assistants, mobile phones, and other mobile computing devices. For brevity and clarity and unless specifically stated otherwise, the term “EGM” is used herein to refer to an electronic gaming machine (such as a slot machine, a video poker machine, a video lottery terminal (VLT), a gaming terminal associated with one or more table games occurring at one or more gaming tables, a video keno machine, or a video bingo machine located on a casino floor). Additionally, for brevity and clarity and unless specifically stated otherwise, “EGM” as used herein represents one EGM or a plurality of EGMs, “secondary device” as used herein represents one secondary device or a plurality of secondary devices, and “central server, central controller, or remote host” as used herein represents one central server, central controller, or remote host or a plurality of central servers, central controllers, or remote hosts.

As noted above, in various embodiments, a gaming establishment component is configured to communicate with the central server, central controller, or remote host through a data network or remote communication link, such as a local area network or a wide area network. In certain such embodiments, the gaming establishment component is configured to communicate with another gaming establishment component through the same data network or remote communication link or through a different data network or remote communication link. In certain embodiments in which the gaming establishment component operates with a central server, central controller, or remote host, the central server, central controller, or remote host is any suitable computing device (such as a server) that includes at least one processor and at least one memory device or data storage device. As further described herein, the gaming establishment component includes at least one gaming establishment component processor configured to transmit and receive data or signals representing events, messages, commands, or any other suitable information between the gaming establishment component and the central server, central controller, or remote host. The at least one processor of that gaming establishment component is configured to execute the events, messages, or commands represented by such data or signals in conjunction with the operation of the gaming establishment component. Moreover, the at least one processor of the central server, central controller, or remote host is configured to transmit and receive data or signals representing events, messages, commands, or any other suitable information between the central server, central controller, or remote host and the gaming establishment component. The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the gaming establishment component. Further, one, more than one, or each of the functions of the at least one processor of the gaming establishment component may be performed by the at least one processor of the central server, central controller, or remote host.

In certain such embodiments, computerized instructions for controlling the gaming establishment component are executed by the central server, central controller, or remote host. In such “thin client” embodiments, the central server, central controller, or remote host remotely controls the information displayed by the gaming establishment component, wherein the gaming establishment component is utilized to display such information and to receive one or more inputs or commands. In other such embodiments, computerized instructions for controlling the gaming establishment component are communicated from the central server, central controller, or remote host to the gaming establishment component and are stored in at least one memory device of the gaming establishment component. In such “thick client” embodiments, the at least one processor of the gaming establishment component executes the computerized instructions to control the operation of the gaming establishment component.

### Differentiating Certain Gaming Systems from General Purpose Computing Devices

Certain of the gaming establishment components described herein, such as EGMs located in a casino or another gaming establishment, include certain components and/or are configured to operate in certain manners that differentiate these systems from general purpose computing devices, i.e., certain personal gaming devices such as desktop computers and laptop computers.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general purpose computing device.

A second difference between EGMs and general purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code. Examples of EGM code authentication are described in U.S. Pat. No. 6,962,530, entitled “Authentication in a Secure Computerized Gaming System”; U.S. Pat. No. 7,043,641, entitled “Encryption in a Secure Computerized Gaming System”; U.S. Pat. No. 7,201,662, entitled “Method and Apparatus for Software Authentication”; and U.S. Pat. No. 8,627,097, entitled “System and Method Enabling Parallel Processing of Hash Functions Using Authentication Checkpoint Hashes”.

A fourth difference between EGMs and general purpose computing devices is that EGMs have unique peripheral device requirements that differ from those of a general purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion. Examples of a state-based EGM, recovery from malfunctions, and game history are described in U.S. Pat. No. 6,804,763, entitled “High Performance Battery Backed RAM Interface”; U.S. Pat. No. 6,863,608, entitled “Frame Capture of Actual Game Play”; U.S. Pat. No. 7,111,141, entitled “Dynamic NV-RAM”; and U.S. Pat. No. 7,384,339, entitled, “Frame Capture of Actual Game Play”.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives. Examples of trusted memory devices are described in U.S. Pat. No. 6,685,567, entitled “Process Verification”.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected. Examples of trusted memory devices/sources are described in U.S. Pat. No. 7,515,718, entitled “Secured Virtual Network in a Gaming Environment”.

Mass storage devices used in a general purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present. Examples of using a mass storage device are described in U.S. Pat. No. 6,149,522, entitled “Method of Authenticating Game Data Sets in an Electronic Casino Gaming System”.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

The invention is claimed as follows:

1. A gaming establishment component comprising:
a network interface;
a processor; and
a memory device which stores a plurality of instructions, which when executed by the processor, cause the processor to:
responsive to an occurrence of an initiation of an authenticable task, wirelessly communicate, via the network interface and to a mobile device, data associated with the authenticable task, and
responsive to receipt, via the network interface and from the mobile device, of data authenticating a user of the mobile device, continue with the authenticatable task.

2. The gaming establishment component of claim 1, wherein the data authenticating the user of the mobile device comprises biometric data associated with the user.

3. The gaming establishment component of claim 1, wherein the data authenticating the user of the mobile device is determined by a mobile device authenticator application of the mobile device.

4. The gaming establishment component of claim 1, wherein the data authenticating the user of the mobile device comprises data associated with a gaming establishment personnel.

5. The gaming establishment component of claim 1, wherein the authenticatable task comprises a logging into the gaming establishment component.

6. The gaming establishment component of claim 1, wherein the authenticatable task comprises an authorization of a transaction.

7. The gaming establishment component of claim 1, wherein when executed by the processor, the instructions cause the processor to continue with the authenticatable task via communicating the data authenticating the user of the mobile device to a server.

8. The gaming establishment component of claim 1, wherein the processor comprises a processor of a gaming establishment workstation.

9. A gaming establishment component comprising:
a network interface;
a processor; and
a memory device which stores a plurality of instructions, which when executed by the processor, cause the processor to:
responsive to an occurrence of an initiation of an authenticable task, wirelessly communicate, via the network interface and to a mobile device, data associated with the authenticable task, and
responsive to an authentication of a user of the mobile device associated with the authenticable task, associate a digital signature of the user of the mobile device with the authenticable task, wherein the authentication of the user of the mobile device is based on data authenticating the user of the mobile device received from the mobile device.

10. The gaming establishment component of claim 9, wherein when executed by the processor, the instructions cause the processor to associate the digital signature of the user of the mobile device with the authenticable task via associating the digital signature of the user of the mobile device with a digital transaction slip associated with the authenticable task.

11. The gaming establishment component of claim 9, wherein when executed by the processor, the instructions cause the processor to store the digital signature of the user of the mobile device associated with the authenticable task.

12. The gaming establishment component of claim 9, wherein the authentication of the user of the mobile device is associated with receipt of user verification data from a server.

13. The gaming establishment component of claim 9, wherein the digital signature of the user of the mobile device comprises a digital signature of a gaming establishment personnel.

14. A method of operating a gaming establishment component, the method comprising:
responsive to an occurrence of an initiation of an authenticable task, wirelessly communicating, via a network interface and to a mobile device, data associated with the authenticable task, and
responsive to receipt, via the network interface and from the mobile device, of data authenticating a user of the mobile device, continuing, by a processor, with the authenticatable task.

15. The method of claim 14, wherein the data authenticating the user of the mobile device comprises biometric data associated with the user.

16. The method of claim 14, wherein the data authenticating the user of the mobile device is determined by a mobile device authenticator application of the mobile device.

17. The method of claim 14, wherein the data authenticating the user of the mobile device comprises data associated with a gaming establishment personnel.

18. The method of claim 14, wherein the authenticatable task comprises a logging into the gaming establishment component.

19. The method of claim 14, wherein the authenticatable task comprises an authorization of a transaction.

20. The method of claim 14, further comprising continuing with the authenticatable task via communicating the data authenticating the user of the mobile device to a server.
